(19) United States
(12) Patent Application Publication
(10) Pub. No.: US 2017/0030340 A1
(43) Pub. Date: Feb. 2, 2017

(54) VALVE FOR A DOWNHOLE PUMP

(71) Applicant: Weatherford Technology Holdings, LLC, Houston, TX (US)

(72) Inventors: Michael C. KNOELLER, Humble, TX (US); Gabriel LUGO, Katy, TX (US)

(21) Appl. No.: 15/215,200

(22) Filed: Jul. 20, 2016

Related U.S. Application Data
(60) Provisional application No. 62/197,457, filed on Jul. 27, 2015.

(51) Int. Cl. F04B 7/02; F04B 19/22; E21B 43/12; F04B 53/14; F04B 53/16; F04B 53/10; F16K 15/04; F04B 47/00

(52) U.S. Cl. CPC F04B 7/0208; F16K 15/044; F04B 19/22; F04B 47/00; F04B 53/14; F04B 53/16; F04B 53/102; E21B 43/126

(57) ABSTRACT

A valve assembly includes a valve body having a first port and a second port, the first port forms a fluid pathway from a first surface of the valve body to a second surface of the valve body, and the second port forms a fluid pathway from the second surface of the valve body to a third surface of the valve body; a first plate having a first blocking member, the first blocking member configured to block the first port at the first surface of the valve body when the first plate is in a first closed position; and a second plate having a second blocking member, the second blocking member configured to block the second port at the second surface of the valve body when the second plate is in a second closed position.

### BACKGROUND OF THE INVENTION

Field of the Invention

Embodiments of the present invention generally relate to valves for use in downhole pumps.

Description of the Related Art

Pumps can be used in wells to help bring production fluids (such as gas or other hydrocarbons) to the surface. This is often referred to as providing artificial lift, as the reservoir pressure is insufficient for the production fluid to reach the surface on its own.

One type of pump for such operations is a hydraulically-actuated double-acting piston pump. This type of pump is typically deployed downhole in tubing, which is disposed in a wellbore casing. Surface equipment injects power fluid (e.g., produced water or oil) down the tubing to the pump. The power fluid operates to drive an engine piston internally between upstrokes and downstrokes which, in turn, drives a pump piston connected to the engine piston via a rod.

During alternating strokes, the pump simultaneously draws in production fluid into the tubing and discharges production fluid out of the tubing. The production fluid discharged from the pump accumulates and rises to the surface for handling.

Hydraulic piston pumps often include check valves to control production fluid flow during the upstrokes and downstrokes. Assuming a pump that operates in a manner described above, a first check valve discharges production fluid during an upstroke while a second check valve collects production fluid. During a downstroke, the first check valve collects production fluid while the second check valve discharges production fluid.

There is a need for improved check valves to control production fluid flow during the strokes of the pump.

### SUMMARY OF THE INVENTION

In one embodiment, a valve assembly includes a valve body having a first port and a second port, the first port forms a fluid pathway from a first surface of the valve body to a second surface of the valve body, and the second port forms a fluid pathway from the second surface of the valve body to a third surface of the valve body; a first plate having a first blocking member, the first blocking member configured to block the first port at the first surface of the valve body when the first plate is in a first closed position; and a second plate having a second blocking member, the second blocking member configured to block the second port at the second surface of the valve body when the second plate is in a second closed position.

In another embodiment, a method of forming a valve assembly includes providing a valve body with a port that forms a fluid pathway from a first surface of the valve body to a second surface of the valve body, wherein the port at the first surface forms a seat; disposing a blocking member in the seat; and attaching a plate to the blocking member disposed in the seat.

In another embodiment, a pump assembly includes a pump piston designed to move up and down in alternating strokes between an upper pump volume and a lower pump volume; and a first and second valve assemblies, each valve assembly comprising: a valve body with an outlet port and an inlet port, a first plate having a blocking member coupled thereto for blocking the outlet port when the first plate is in a closed position, and a second plate having a blocking member coupled thereto for blocking the inlet port when the second plate is in a closed position, wherein the first valve assembly allows fluid out of the upper pump volume via the outlet port in the first valve body during an upstroke of the pump piston, and allows fluid into the upper pump volume via the inlet port in the first valve body during a downstroke of the pump piston, and wherein the second valve assembly allows fluid out of the lower pump volume via the outlet port in the second valve body during the downstroke of the pump piston, and allows fluid into the lower pump volume via the inlet port in the second valve body during the upstroke of the pump piston.

In another embodiment, a method of pumping fluid from a wellbore includes deploying a pump assembly into the wellbore, the pump assembly having a pump piston and a first and second valve assembly, each valve assembly comprising: a valve body with an outlet port and an inlet port, a first plate coupled with a blocking member for blocking the outlet port when the first plate is in a closed position, and a second plate coupled with a blocking member for blocking the inlet port when the second plate is in a closed position; driving the piston pump in an upstroke, thereby unseating the blocking member of the first plate in the first valve assembly and unseating the blocking member of the second plate in the second valve assembly; and driving the piston pump in a downstroke, thereby unseating the blocking member of the second plate in the first valve assembly and unseating the blocking member of the first plate in the second valve assembly.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an embodiment of a system for pumping fluid from a wellbore.

FIG. 2A is a section view of an exemplary upper valve assembly during a downstroke.

FIG. 2B is a section view of the upper valve assembly of FIG. 2A during an upstroke.

FIG. 3A is a section view of an exemplary lower valve assembly during an upstroke.

FIG. 3B is a section view of the lower valve assembly of FIG. 3A during a downstroke.

FIG. 4 illustrates the upper valve assembly of FIG. 2A and the lower valve assembly of FIG. 3A during the upstroke.

FIG. 5 illustrates the upper valve assembly of FIG. 2A and the lower valve assembly of FIG. 3A during the downstroke.

### DETAILED DESCRIPTION

Embodiments of the present disclosure generally relate to a piston pump with an upper and lower valve assembly for pumping fluid from a wellbore.

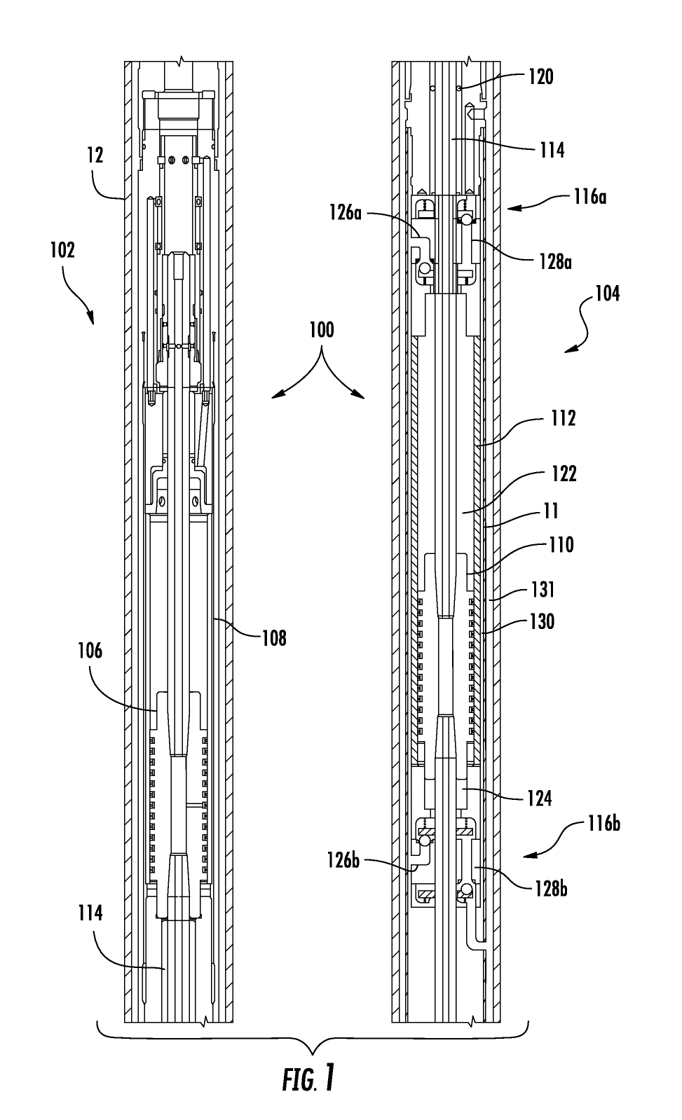

FIG. 1 illustrates an embodiment of a pump system 100 for pumping fluid from a wellbore. The pump system 100 is housed in a tubular 12, such as production tubing 12. In one embodiment, the production tubing 12 is disposed in a casing. The pump system 100 generally includes an engine section 102 and a pump section 104. The engine section 102, such as the engine section disclosed in U.S. Pat. No. 8,303,272, which is incorporated herein by reference, has an engine piston 106 movably disposed within an engine barrel 108. Similarly, the pump section 104 has a pump piston 110 movably disposed in a pump barrel 112. The pump piston 110 divides the pump barrel 112 between an upper pump volume 122 and a lower pump volume 124. An upper valve assembly 116a is disposed at an upper end of the pump barrel 112 and a lower valve assembly 116b is disposed at a lower of the pump barrel 112. In one embodiment, the upper and lower valve assemblies 116a, 116b and the pump barrel 112 are disposed in an outer tube 11, thereby forming an annulus 130 therebetween. The annulus 130 is in fluid communication with production fluid (such as gas or other hydrocarbons) in a formation via a flow path in the pump system 100. The outer tube 11 and the production tubing 12 form an annulus 131 for collecting exhausted production fluid from the upper and lower valve assemblies 116a, 116b. In one embodiment, the upper valve assembly 116a and the lower valve assembly 116b are substantially similarly constructed except that the lower valve assembly 116b is inverted relative to the orientation of the upper valve assembly 116a. For convenience, the components of the upper and lower valve assemblies 116a, 116b that are similar to each other are labeled with the same reference indicator and an “a” or “b,” indicating components belonging to the upper valve assembly 116a or lower valve assembly 116b, respectively.

A rod 114 interconnects the engine piston 106 and the pump piston 110 such that the engine piston 106 and the pump piston 110 move in tandem in their respective barrels. The rod 114 passes through a sealing element 120, such as a seal ring. The sealing element 120 prevents fluid from passing on the outside of the rod 114 between the engine and pump barrels 108, 112.

The engine piston 106 is hydraulically actuated between upward and downward strokes by power fluid communicated from a surface of the wellbore to the pump system 100. As the engine piston 106 strokes, the pump piston 110 alternatingly sucks in production fluid into the upper and lower pump volumes 122, 124 and alternatingly discharges production fluid out of the upper and lower pump volumes 122, 124. For example, during an upstroke, production fluid in the annulus 130 is drawn into the lower pump volume 124 via an inlet port 126b in the lower valve assembly 116b, while production fluid is discharged from the upper pump volume 122 to the annulus 131 via an outlet port 128a in the upper valve assembly 116a. During a downstroke, production fluid in the annulus 130 is drawn into the upper pump volume 122 via an inlet port 126a in the upper valve assembly 116a, while production fluid is discharged from the lower pump volume 124 to the annulus 131 via an outlet port 128b in the lower valve assembly 116b. In one embodiment, the production fluid discharged through the outlet ports 128a, 128b collects in the annulus 131 until the production fluid reaches the surface.

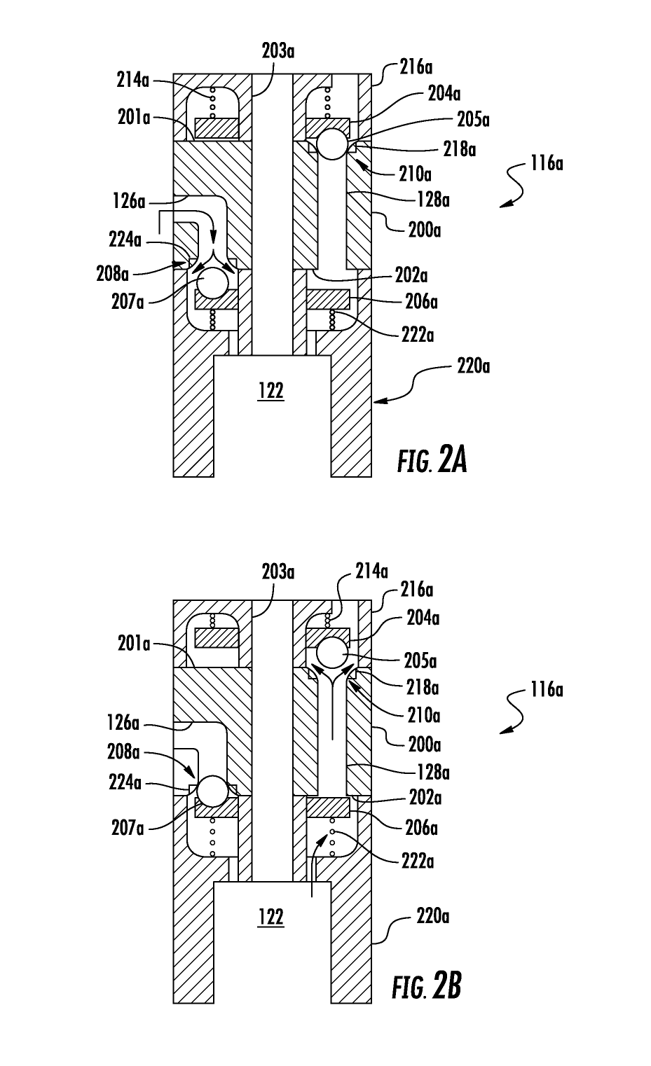

An exemplary embodiment of the upper valve assembly 116a is shown in FIGS. 2A and 2B. FIG. 2A shows the upper valve assembly 116a during the downstroke of the pump piston 110. During the downstroke, the upper valve assembly 116a draws fluid into the upper pump volume 122 via the inlet port 126a, while blocking a backflow of fluid into the upper pump volume 122 through the outlet port 128a.

The upper valve assembly 116a includes a bore 203a therethrough for receiving the rod 114. The upper valve assembly 116a also includes a valve body 200a having the inlet port 126a and the outlet port 128a, as shown in FIGS. 2A and 2B. In one embodiment, the outlet port 128a forms a fluid pathway from the upper pump volume 122 to the annulus 131. The outlet port 128a includes a seat 210a for receiving a first blocking member 205a of an exhaust plate 204a. In some embodiments, the first blocking member 205a is only free to rotate, if at all, about an axis that is parallel with the outlet port 128a. In some embodiments, the first blocking member 205a is not free to rotate relative to the outlet port 128a. The first blocking member 205a may be coupled to the exhaust plate 204a. For example, in one embodiment, the exhaust plate 204a and the first blocking member 205a are integrally formed. For example, the exhaust plate 204a and the first blocking member 205a are machined from a single piece of material, such as steel. In another embodiment, the first blocking member 205a is attached to the exhaust plate 204a. For example, to attach the exhaust plate 204a to the first blocking member 205a, the first blocking member 205a is disposed in the seat 210a formed by the outlet port 128a. Next, the exhaust plate 204a is attached to the first blocking member 205a while the first blocking member 205a is disposed in the seat 210a. The exhaust plate 204a may be attached to the first blocking member 205a using any suitable method of adhesion, including brazing, welding, and/or gluing. An exhaust cage 216a may then be attached to the valve body 200a. An optional biasing member 214a may be disposed between the exhaust plate 204a and the exhaust cage 216a when the exhaust cage 216a is attached to the valve body 200a.

In one embodiment, the exhaust plate 204a with first blocking member 205a is movably disposed in an exhaust cage 216a between an open position (FIG. 2B) and a closed position (FIG. 2A). The exhaust plate 204a may be biased toward the closed position by a biasing member 214a, such as a spring, which is disposed between the exhaust plate 204a and the exhaust cage 216a. In the closed position, the first blocking member 205a contacts the seat 210a to block the outlet port 128a, as shown in

FIG. 2A. The first blocking member 205a may or may not hermetically seal the outlet port 128a in the closed position. The biasing member 214a and a hydrostatic pressure in the annulus 131 may act on the exhaust plate 204a such that the first blocking member 205a engages the seat 210a to block the outlet port 128a. For example, when the hydrostatic pressure in the annulus 131 is greater than the fluid pressure in the upper pump volume 122, the first blocking member 205a moves towards the closed position. The first blocking member 205a may have any appropriate shape capable of mating with the seat 210a, such as a conical solid, a rectangular solid, or an ellipsoid. In one embodiment, the first blocking member 205a is a ball, as shown in FIGS. 2A and 2B. The seat 210a may include a mating surface having a contoured profile corresponding to the shape of the first blocking member 205a. In one example, the seat 210a includes a rounded mating surface, i.e., a radius cut, for engaging the first blocking member 205a as shown in FIGS. 2A and 2B. In another example, the seat 210a includes a mating surface forming a 90 degree angle, i.e., a 90 degree cut, for engaging the first blocking member 205a. The seat 210a may also include a carbide insert 218a at the mating surface, as shown in FIGS. 2A and 2B.

In operation, the exhaust plate 204a with first blocking member 205a moves to the closed position during the downstroke of the pump piston 110. For example, the upper pump volume 122 increases during the downstroke, thereby causing a fluid pressure decrease in the upper pump volume 122. In turn, a fluid pressure differential is created across the exhaust plate 204a whereby the hydrostatic pressure in the annulus 131 is greater than the fluid pressure in the upper pump volume 122. The biasing member 214a and/or the hydrostatic pressure in the annulus 131 act on the exhaust plate 204a such that the first blocking member 205a is urged against the seat 210a. As a result, the first blocking member 205a blocks the backflow of fluid from the annulus 131 to the upper pump volume 122 via the outlet port 128a during the downstroke.

In one embodiment, the inlet port 126a forms a fluid pathway from the annulus 130 to the upper pump volume 122. In one embodiment, the inlet port 126a is an angled port, as shown in FIGS. 2A and 2B. The inlet port 126a includes a seat 208a for receiving a second blocking member 207a of an intake plate 206a. In some embodiments, the second blocking member 207a is only free to rotate, if at all, about an axis that is parallel with the inlet port 126a. In some embodiments, the second blocking member 207a is not free to rotate relative to the inlet port 126a. The second blocking member 207a may be coupled to the intake plate 206a. For example, the intake plate 206a and the second blocking member 207a may be integrally formed or, alternatively, attached to each other. The second blocking member 207a may be attached to the intake plate 206a in a similar manner as described in relation to the first blocking member 205a and the exhaust plate 204a. For example, the second blocking member 207a is first disposed in the seat 208a, and the intake plate 206a is subsequently attached to the second blocking member 207a while the second blocking member 207a is disposed in the seat 208a. The intake plate 206a may be attached to the second blocking member 207a using any suitable method of adhesion, including brazing, welding, and/or gluing. An intake cage 220a may then be attached to the valve body 200a. An optional biasing member 222a may be disposed between the intake plate 206a and the intake cage 220a when the intake cage 220a is attached to the valve body 200a.

The intake plate 206a with second blocking member 207a is movably disposed in an intake cage 220a between an open position (FIG. 2A) and a closed position (FIG. 2B). In one embodiment, the intake plate 206a is biased toward the closed position by a biasing member 222a, such as a spring, which is disposed between the intake plate 206a and the intake cage 220a. In the closed position, the second blocking member 207a contacts the seat 208a to block the inlet port 126a, as shown in FIG. 2B. The second blocking member 207a may or may not hermetically seal the inlet port 126a in the closed position. The biasing member 222a and a fluid pressure in the upper pump volume 122 act on the intake plate 206a such that the second blocking member 207a engages the seat 208a to block the inlet port 126a. For example, when the fluid pressure in the upper pump volume 122 is greater than the fluid pressure in the annulus 130, the second blocking member 207a moves towards the closed position. The second blocking member 207a may have any appropriate shape capable of mating with the seat 208a, such as a conical solid, a rectangular solid, or an ellipsoid. In one embodiment, the second blocking member 207a is a ball. The seat 208a may include a mating surface having a contoured profile corresponding to the shape of the second blocking member 207a. For example, the mating surface may include a radius cut or, alternatively, a 90 degree cut for engaging the second blocking member 207a. The seat 208a may also include a carbide insert 224a at the mating surface, as shown in FIGS. 2A and 2B.

The intake plate 206a moves to the open position during the downstroke, as shown in FIG. 2A. In the open position, the second blocking member 207a is configured to allow fluid flow through the inlet port 126a. For example, as the upper pump volume 122 increases during the downstroke, the fluid pressure in the upper pump volume 122 decreases. In turn, the fluid pressure differential is increased across the intake plate 206a whereby the fluid pressure in the annulus 130 is greater than the fluid pressure in the upper pump volume 122. The fluid pressure in the annulus 130 acts on the second blocking member 207a, causing the intake plate 206a to compress the biasing member 222a. As a result, the second blocking member 207a unblocks the inlet port 126a by moving away from the seat 208a. The second blocking member 207a thereby allows fluid flow from the annulus 130 to the upper pump volume 122 via the inlet port 126a. Fluid may flow around the second blocking member 207a in multiple directions, as indicated by the arrows in FIG. 2A. Because the second blocking member 207a is coupled to the intake plate 206a, the second blocking member 207a is not rotated relative to the intake plate 206a during inflow. At least a portion of the second blocking member 207a remains above a plane formed by a lower surface 202a of the valve body 200a, thereby preventing the rotation of the intake plate 206a relative to the intake cage 220a. In one example, a gap between the second blocking member 207a and the mating surface of the seat 208a ranges from 0.0005 inches to 0.005 inches when intake plate 206a is in the open position. In another example, the gap ranges from 0.001 inches to 0.004 inches. In one embodiment, a stiffness of the biasing member 222a prevents a top of the second blocking member 207a from moving below the plane formed by the lower surface 202a. As a result, the intake plate 206amaintains an alignment between the second blocking member 207a and the inlet port 126a during operation.

FIG. 2B shows the upper valve assembly 116a during the upstroke of the pump piston 110. The exhaust plate 204a moves to the open position during the upstroke. In the open position, the first blocking member 205a is configured to allow fluid flow through the outlet port 128a. For example, as the upper pump volume 122 decreases during the upstroke, the fluid pressure in the upper pump volume 122 increases. In turn, a fluid pressure differential is increased across the exhaust plate 204a whereby the fluid pressure in the upper pump volume 122 is greater than the hydrostatic pressure in the annulus 131. The fluid pressure in the upper pump volume 122 acts on the first blocking member 205a, causing the exhaust plate 204a to compress the biasing member 214a. As a result, the first blocking member 205a unblocks the outlet port 128a by moving away from the seat 210a. The first blocking member 205a thereby allows fluid flow from the upper pump volume 122 to the annulus 131 via the outlet port 128a. Fluid may flow around the first blocking member 205a in multiple directions, as indicated by the arrows in FIG. 2B. Because the first blocking member 205a is coupled to the exhaust plate 204a, the first blocking member 205a is not rotated relative to the exhaust plate 204a during outflow. Due to the relatively high pressure and/or relatively low volume in the outlet port 128a per stroke, the exhaust plate 204a may travel a relatively short distance to allow sufficient flow out of the upper pump volume 122. In one example, a gap between the first blocking member 205a and the mating surface of the seat 210a ranges from 0.0005 inches to 0.005 inches when the exhaust plate 204a is in the open position. In another example, the gap ranges from 0.001 inches to 0.004 inches. In one embodiment, by traveling a short distance from the seat 210a, the first blocking member 205a prevents the rotation of the exhaust plate 204a relative to the exhaust cage 216a. For example, in the open position, at least a portion of the first blocking member 205a remains below a plane formed by an upper surface 201a of the valve body 200a. In one embodiment, a stiffness of the biasing member 214a prevents a bottom of the first blocking member 205a from moving above the plane formed by the upper surface 201a. As a result, the exhaust plate 204amaintains an alignment between the first blocking member 205a and the outlet port 128a during operation.

The intake plate 206a with second blocking member 207a moves to the closed position during the upstroke of the pump piston 110, as shown in FIG. 2B. For example, the upper pump volume 122 decreases during the upstroke, thereby causing a fluid pressure increase in the upper pump volume 122. In turn, a fluid pressure differential is created across the intake plate 206a whereby the fluid pressure in the upper pump volume 122 is greater than the fluid pressure in the annulus 130. The biasing member 222a and/or the fluid pressure in the upper pump volume 122 act on the intake plate 206a such that the second blocking member 207a is urged against the seat 208a. As a result, the second blocking member 207a blocks the backflow of fluid from the upper pump volume 122 to the annulus 130 via the inlet port 126a during the upstroke. In the closed position, intake plate 206a may or may not fully block the flow of fluid from upper pump volume 122 to outlet port 128a.

In some embodiments, intake plate 206a and exhaust plate 204a cooperate such that, when the intake plate 206a is in a closed position, the exhaust plate 204a is in an open position, and vice versa.

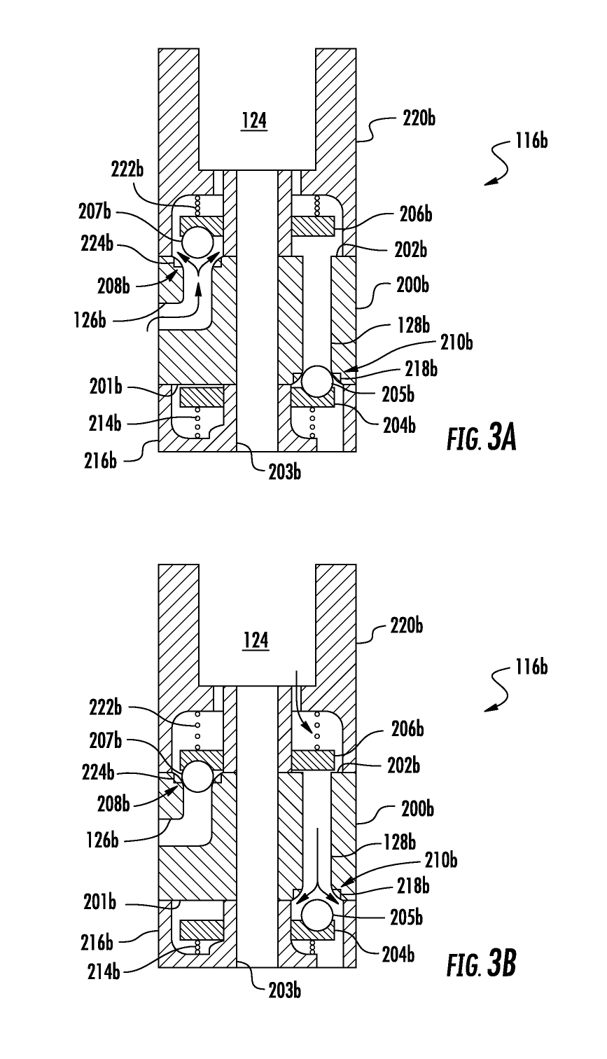

An exemplary embodiment of the lower valve assembly 116b is shown in FIGS. 3A and 3B. As previously mentioned, the lower valve assembly 116b is constructed in a substantially identical fashion as the upper valve assembly 116a. The lower valve assembly 116b includes a bore 203b therethrough for receiving the rod 114. The lower valve assembly 116b also includes a valve body 200b having an inlet port 126b and an outlet port 128b. The outlet port 128b forms a fluid pathway from the lower pump volume 124 to the annulus 131. The outlet port 128b includes a seat 210b for receiving a first blocking member 205b of an exhaust plate 204b. In some embodiments, the first blocking member 205b is only free to rotate, if at all, about an axis that is parallel with the outlet port 128b. In some embodiments, the first blocking member 205b is not free to rotate relative to the outlet port 128b. The first blocking member 205b may be coupled to the exhaust plate 204b. For example, the exhaust plate 204b and the first blocking member 205b of the lower valve assembly 116b may be integrally formed or, alternatively, attached to each other. The first blocking member 205b may be attached to the exhaust plate 204b in a similar manner as described in relation to the first blocking member 205a and the exhaust plate 204a. For example, the first blocking member 205b is first disposed in the seat 210b, and the exhaust plate 204b is subsequently attached to the first blocking member 205b while the first blocking member 205b is disposed in the seat 210b. The exhaust plate 204b may be attached to the first blocking member 205b using any suitable method of adhesion, including brazing, welding, and/or gluing. An exhaust cage 216b may then be attached to the valve body 200b. An optional biasing member 214b may be disposed between the exhaust plate 204b and the exhaust cage 216b when the exhaust cage 216b is attached to the valve body 200b.

The exhaust plate 204b is movably disposed in an exhaust cage 216b between an open position (FIG. 3B) and a closed position (FIG. 3A). In one embodiment, the exhaust plate 204b is biased toward the closed position by a biasing member 214b, such as a spring, which is disposed between the exhaust plate 204b and the exhaust cage 216b. In the closed position, the first blocking member 205b contacts the seat 210b to block the outlet port 128b, as shown in FIG. 3A. The first blocking member 205b may or may not hermetically seal the outlet port 128b in the closed position. The biasing member 214b and the hydrostatic pressure in the annulus 131 act on the exhaust plate 204b such that the first blocking member 205b engages the seat 210b to close the outlet port 128b. For example, when the hydrostatic pressure in the annulus 131 is greater than the fluid pressure in the lower pump volume 124, the first blocking member 205b moves towards the closed position. The first blocking member 205b may have any appropriate shape capable of mating with the seat 210b, such as a conical solid, a rectangular solid, or an ellipsoid. In one embodiment, the first blocking member 205b is a ball. The seat 210b may include a mating surface having a contoured profile corresponding to the shape of the first blocking member 205b. For example, the mating surface may include a radius cut or, alternatively, a 90 degree cut for engaging the first blocking member 205b. The seat 210b may also include a carbide insert 218b at the mating surface, as shown in FIGS. 3A and 3B.

In operation, the exhaust plate 204b moves to the closed position during the upstroke of the pump piston 110. For example, the lower pump volume 124 increases during the upstroke, thereby causing a fluid pressure decrease in the lower pump volume 124. In turn, a fluid pressure differential is created across the exhaust plate 204b whereby the hydrostatic pressure in the annulus 131 is greater than the fluid pressure in the lower pump volume 124. The biasing member 214b and/or the hydrostatic pressure in the annulus 131 act on the exhaust plate 204b such that the first blocking member 205b is urged against the seat 210b. As a result, the first blocking member 205b blocks the backflow of fluid from the annulus 131 to the lower pump volume 124 via the outlet port 128b during the upstroke.

In one embodiment, the inlet port 126b forms a fluid pathway from the annulus 130 to the lower pump volume 124. In one embodiment, the inlet port 126b is an angled port, as shown in FIGS. 3A and 3B. The inlet port 126b includes a seat 208b for receiving a second blocking member 207b of an intake plate 206b. In some embodiments, the second blocking member 207b is only free to rotate, if at all, about an axis that is parallel with the inlet port 126b. In some embodiments, the second blocking member 207b is not free to rotate relative to the inlet port 126b. The second blocking member 207b may be coupled to the intake plate 206b. For example, in one embodiment, the intake plate 206b and the second blocking member 207b are integrally formed or, alternatively, attached to each other. The second blocking member 207b may be attached to the intake plate 206b in a similar manner as described in relation to the second blocking member 207a and the intake plate 206a. For example, the second blocking member 207b is first disposed in the seat 208b, and the intake plate 206b is subsequently attached to the second blocking member 207a while the second blocking member 207b is disposed in the seat 208b. The intake plate 206b may be attached to the second blocking member 207b using any suitable method of adhesion, including brazing, welding, and/or gluing. An intake cage 220b may then be attached to the valve body 200b. An optional biasing member 222B may be disposed between the intake plate 206b and the intake cage 220b when the intake cage 220b is attached to the valve body 200b.

The intake plate 206b is movably disposed in an intake cage 220b between an open position (FIG. 3A) and a closed position (FIG. 3B). In one embodiment, the intake plate 206b is biased toward the closed position by a biasing member 222b, such as a spring. In the closed position, the second blocking member 207b contacts the seat 208b to block the inlet port 126b, as shown in FIG. 3B. The second blocking member 207b may or may not hermetically seal the inlet port 126b in the closed position. The biasing member 222b and the fluid pressure in the lower pump volume 124 act on the intake plate 206b such that the second blocking member 207b engages the seat 208b to block the inlet port 126b. For example, when the fluid pressure in the lower pump volume 124 is greater than the pressure in the annulus 130, the second blocking member 207b moves towards the closed position. The second blocking member 207b may have any appropriate shape capable of mating with the seat 208b, such as a conical solid, a rectangular solid, or an ellipsoid. In one embodiment, the second blocking member 207b is a ball. The seat 208b may include a mating surface having a contoured profile corresponding to the shape of the second blocking member 207b. For example, the mating surface may include a radius cut or, alternatively, a 90 degree cut for engaging the second blocking member 207b. The seat 208b may also include a carbide insert 224b at the mating surface, as shown in FIGS. 3A and 3B.

The intake plate 206b moves to the open position during the upstroke of the pump piston 110, as shown in FIG. 3A. In the open position, the second blocking member 207b is configured to allow fluid flow through the inlet port 126b. For example, as the lower pump volume 124 increases during the upstroke, the fluid pressure in the lower pump volume 124 decreases. In turn, a fluid pressure differential is created across the intake plate 206a whereby the pressure in the annulus 130 is greater than the fluid pressure in the lower pump volume 124. The fluid pressure in the annulus 130 acts on the second blocking member 207b, causing the intake plate 206b to compress the biasing member 222b. As a result, the second blocking member 207b unblocks the inlet port 126b by moving away from the seat 208b. The second blocking member 207bthereby allows fluid flow from the annulus 130 to the lower pump volume 124 via the inlet port 126b. Fluid may flow around the second blocking member 207b in multiple directions, as indicated by the arrows in FIG. 3A. Because the second blocking member 207b is coupled to the intake plate 206b, the second blocking member 207b is not rotated relative to the intake plate 206b during inflow. At least a portion of the second blocking member 207b remains below a plane formed by an upper surface 202b of the valve body 200b, thereby preventing rotation of the intake plate 206b relative to the intake cage 220b. In one example, a gap between the second blocking member 207b and the mating surface of the seat 208b ranges from 0.0005 inches to 0.005 inches when the intake plate 206b is in the open position. In another example, the gap ranges from 0.001 inches to 0.004 inches. In one embodiment, a stiffness of the biasing member 222b prevents a bottom of the second blocking member 207b from moving above the plane formed by the upper surface 202b. As a result, the intake plate 206b maintains an alignment between the second blocking member 207b and the inlet port 126b.

FIG. 3B shows the lower valve assembly 116b during the downstroke of the pump piston 110. The exhaust plate 204b moves to the open position during the downstroke. In the open position, the first blocking member 205b is configured to allow fluid flow through the outlet port 128b. For example, as the lower pump volume 124 decreases during the downstroke, the fluid pressure in the lower pump volume 124 increases. In turn, a fluid pressure differential is increased across the exhaust plate 204b whereby the fluid pressure in the lower pump volume 124 is greater than the hydrostatic pressure in the annulus 131. The fluid pressure in the lower pump volume 124 acts on the first blocking member 205b, causing the exhaust plate 204b to compress the biasing member 214b. As a result, the first blocking member 205b unblocks the outlet port 128b by moving away from the seat 210b. The first blocking member 205b thereby allows fluid flow from the lower pump volume 124 to the annulus 131 via the outlet port 128b. Fluid may flow around the first blocking member 205b in multiple directions, as indicated by the arrows in FIG. 3B. Because the first blocking member 205b is coupled to the exhaust plate 204b, the first blocking member 205b is not rotated relative to the exhaust plate 204b during outflow. The first blocking member 205b prevents the rotation of the exhaust plate 204b relative to the exhaust cage 216b. In one example, a gap between the first blocking member 205b and the mating surface of the seat 210b ranges from 0.0005 inches to 0.005 inches when the exhaust plate 204b is in the open position. In another example, the gap ranges from 0.001 inches to 0.004 inches. In one embodiment, a stiffness of the biasing member 214b prevents a top of the first blocking member 205b from moving below a plane formed by a lower surface 201b of the valve body 200b. As a result, the exhaust plate 204b maintains an alignment between the first blocking member 205b and the outlet port 128b during operation.

The intake plate 206b moves to the closed position during the downstroke of the pump piston 110. For example, the lower pump volume 124 decreases during the downstroke, thereby causing a fluid pressure increase in the lower pump volume 124. In turn, a fluid pressure differential is created across the intake plate 206b whereby the fluid pressure in the lower pump volume 124 is greater than the fluid pressure in the annulus 130. The biasing member 222b and/or the fluid pressure in the lower pump volume 124 act on the intake plate 206b such that the second blocking member 207b is urged against the seat 208b. As a result, the second blocking member 207b blocks the backflow of fluid from the lower pump volume 124 to the annulus 130 via the inlet port 126b during the downstroke. In the closed position, intake plate 206b may or may not fully block the flow of fluid from lower pump volume 124 to outlet port 128b.

In some embodiments, intake plate 206b and exhaust plate 204b cooperate such that, when the intake plate 206b is in a closed position, the exhaust plate 204b is in an open position, and vice versa.

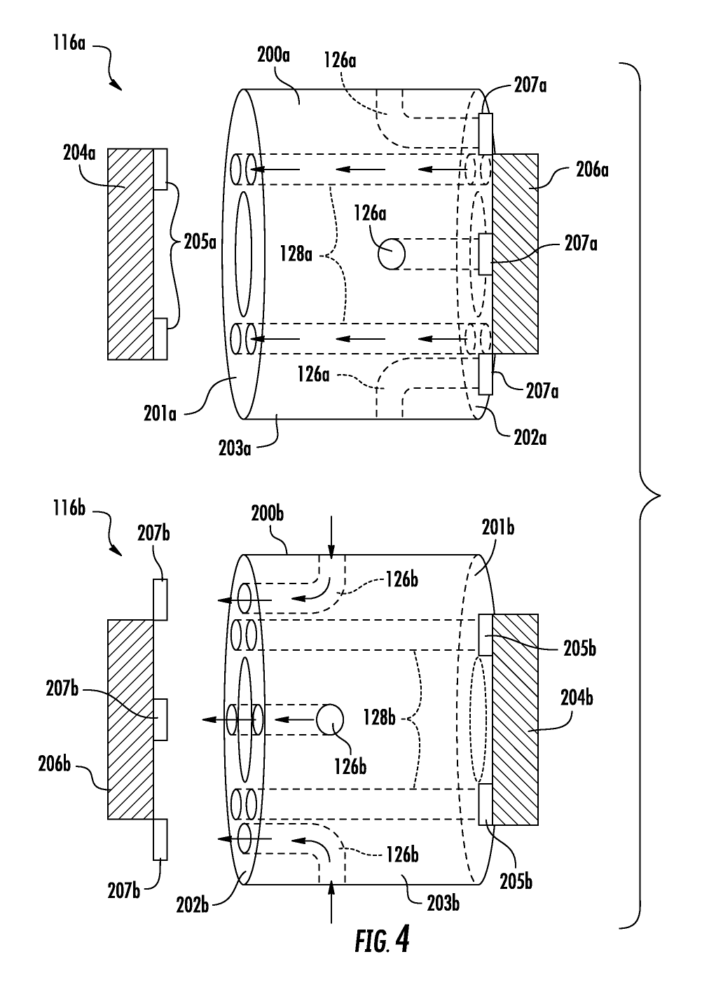

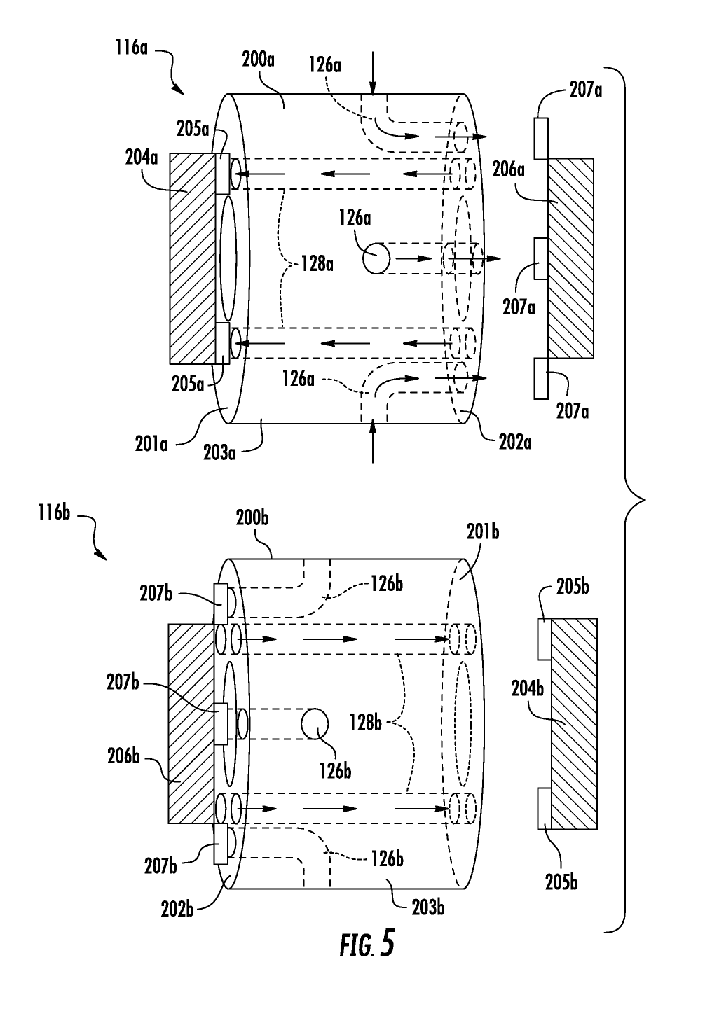

While the valve body 200 in each upper and lower valve assembly 116a, 116b only shows a single inlet port 126 and outlet port 128, each valve body 200 may have multiple ports of each type with corresponding blocking members, as is more clearly shown in FIGS. 4 and 5. In one embodiment, the number of inlet ports 126 ranges from 1 to 6. In another embodiment, the number of inlet ports 126 ranges from 2 to 5. In one embodiment, the number of outlet ports 128 ranges from 1 to 10. In another embodiment, the number of outlet ports 128 ranges from 4 to 8. The blocking members 205, 207 of each plate 204, 206 may be arranged circumferentially about the plate to align with respective inlet and outlet ports, as shown in FIGS. 4 and 5.

The upper and lower valve assemblies 116a, 116b may operate in a complementary manner during alternating pump piston strokes. For example, during the upstroke of the pump piston 110, the exhaust plate 204a of the upper valve assembly 116a is in the open position while the intake plate 206a is in the closed position, as shown in FIG. 4. At the same time, the exhaust plate 204b of the lower valve assembly 116b is in the closed position while the intake plate 206b is in the open position. During the downstroke of the pump piston 110, the exhaust plate 204a of the upper valve assembly 116a is in the closed position while the intake plate 206a is in the open position, as shown in FIG. 5. At the same time, the exhaust plate 204b of the lower valve assembly 116b is in the open position while the intake plate 206b is in the closed position.

In one embodiment, the exhaust plate 204a in the upper valve assembly 116a may selectively allow fluid flow through the some of the outlet ports 128a while blocking fluid flow through other outlet ports 128a. During the upstroke, a first portion of the exhaust plate 204a may move from the closed position to the open position while a second portion of the exhaust plate 204a remains in the closed position. For example, at least one of the first blocking members 205a in the first portion of the exhaust plate 204a move away from a respective seat 210a, thereby allowing fluid flow through the respective outlet port 128a. At the same time, at least one of the first blocking members 205a in the second portion of the exhaust plate 204a remains engaged with a respective seat 210a, thereby blocking fluid flow through the respective outlet port 128a. In this configuration, the exhaust plate 204a is tilted relative to the exhaust cage 216a. The exhaust plate 204b and the intake plates 206a, 206b may similarly tilt to selectively allow fluid flow through some ports while blocking fluid flow through other ports during alternating pump piston strokes.

The plates and blocking members described herein may comprise any appropriate material, such as metal, rubber, and/or plastic. Each blocking member may include any appropriate shape, such as a conical solid, a rectangular solid, or an ellipsoid.

In one embodiment, a valve assembly includes a valve body having a first port and a second port, the first port forms a fluid pathway from a first surface of the valve body to a second surface of the valve body, and the second port forms a fluid pathway from the second surface of the valve body to a third surface of the valve body; a first plate having a first blocking member, the first blocking member configured to block the first port at the first surface of the valve body when the first plate is in a first closed position; and a second plate having a second blocking member, the second blocking member configured to block the second port at the second surface of the valve body when the second plate is in a second closed position.

In one or more of the embodiments described herein, the first blocking member is only free to rotate about an axis that is parallel with the first port.

In one or more of the embodiments described herein, the second blocking member is only free to rotate about an axis that is parallel with the second port.

In one or more of the embodiments described herein, the first blocking member is not free to rotate relative to the first port.

In one or more of the embodiments described herein, the second blocking member is not free to rotate relative to the second port.

In one or more of the embodiments described herein, the valve body includes a plurality of first ports and the first plate includes a plurality of corresponding first blocking members.

In one or more of the embodiments described herein, the valve body includes a plurality of second ports and the second plate includes a plurality of corresponding second blocking members.

In one or more of the embodiments described herein, the first blocking member is coupled to the first plate.

In one or more of the embodiments described herein, the first blocking member is formed integrally with the first plate.

In one or more of the embodiments described herein, the first blocking member is attached to the first plate.

In one or more of the embodiments described herein, the first blocking member is brazed to the first plate.

In one or more of the embodiments described herein, the first blocking member is welded to the first plate.

In one or more of the embodiments described herein, the first blocking member is glued to the first plate.

In one or more of the embodiments described herein, the second blocking member is coupled to the second plate.

In one or more of the embodiments described herein, the second blocking member is formed integrally with the second plate.

In one or more of the embodiments described herein, the second blocking member is attached to the second plate.

In one or more of the embodiments described herein, the second blocking member is brazed to the second plate.

In one or more of the embodiments described herein, the second blocking member is welded to the second plate.

In one or more of the embodiments described herein, the second blocking member is glued to the second plate.

In one or more of the embodiments described herein, the first port has a profile at the first surface of the valve body for receiving the first blocking member.

In one or more of the embodiments described herein, the profile in the first port corresponds to a shape of the first blocking member.

In one or more of the embodiments described herein, the second port has a profile at the second surface of the valve body for receiving the second blocking member.

In one or more of the embodiments described herein, the profile in the second port corresponds to a shape of the second blocking member.

In one or more of the embodiments described herein, the first and second plates are configured to operate in a reciprocal manner.

In one or more of the embodiments described herein, the first and second plates are configured to cooperate such that, when the first plate is in the first closed position, the second plate is in an open position, and vice versa.

In one or more of the embodiments described herein, when the first plate is in the first closed position, the second plate is in an open position.

In one or more of the embodiments described herein, when the second plate is in the second closed position, the first plate is in an open position.

In one or more of the embodiments described herein, the first blocking member is configured to hermetically seal the first port.

In one or more of the embodiments described herein, the first blocking member includes a conical solid, a rectangular solid, or an ellipsoid.

In one or more of the embodiments described herein, the first blocking member comprises a metal material, a rubber material, or a plastic material.

In one or more of the embodiments described herein, the second blocking member is configured to hermetically seal the second port.

In one or more of the embodiments described herein, the second blocking member includes a conical solid, a rectangular solid, or an ellipsoid.

In one or more of the embodiments described herein, the second blocking member comprises a metal material, a rubber material, or a plastic material.

In one or more of the embodiments described herein, the valve assembly further includes a first cage, wherein the first plate is movably disposed in the first cage between an open position and the first closed position.

In one or more of the embodiments described herein, the valve assembly further includes a biasing member between the first plate and the first cage for biasing the first plate towards the first closed position.

In one or more of the embodiments described herein, the valve assembly further includes a second cage, wherein the second plate is movably disposed in the second cage between an open position and the second closed position.

In one or more of the embodiments described herein, the valve assembly further includes a biasing member between the second plate and the second cage for biasing the second plate towards the second closed position.

In one or more of the embodiments described herein, the valve assembly also includes a cage assembly configured to facilitate sliding of the first and second plate relative to the valve body, the cage assembly comprising: a first portion having a base between an inner cylindrical section and an outer cylindrical section, the first plate disposed between the inner and outer cylindrical sections of the first portion; and a second portion having a base between an inner cylindrical section and an outer cylindrical section, the second plate disposed between the inner and outer cylindrical sections of the second portion.

In one or more of the embodiments described herein, the valve assembly also includes a biasing member between the first plate and the base of the first portion for biasing the first plate towards the closed position.

In one or more of the embodiments described herein, the valve assembly also includes a biasing member between the second plate and the base of the second portion for biasing the second plate towards the closed position.

In another embodiment, a method of forming a valve assembly includes providing a valve body with a port that forms a fluid pathway from a first surface of the valve body to a second surface of the valve body, wherein the port at the first surface forms a seat; disposing a blocking member in the seat; and attaching a plate to the blocking member disposed in the seat.

In one or more of the embodiments described herein, the method further includes attaching a cage to the valve body, wherein a biasing member is disposed between the plate and the cage.

In one or more of the embodiments described herein, the valve body includes a plurality of ports forming a plurality of seats, and the plate is attached to a plurality of corresponding blocking members disposed in the plurality of seats.

In one or more of the embodiments described herein, attaching the plate to the blocking member includes gluing, welding, and/or brazing the plate to the blocking member.

In another embodiment, a pump assembly includes a pump piston designed to move up and down in alternating strokes between an upper pump volume and a lower pump volume; and a first and second valve assemblies, each valve assembly comprising: a valve body with an outlet port and an inlet port, a first plate having a blocking member coupled thereto for blocking the outlet port when the first plate is in a closed position, and a second plate having a blocking member coupled thereto for blocking the inlet port when the second plate is in a closed position, wherein the first valve assembly allows fluid out of the upper pump volume via the outlet port in the first valve body during an upstroke of the pump piston, and allows fluid into the upper pump volume via the inlet port in the first valve body during a downstroke of the pump piston, and wherein the second valve assembly allows fluid out of the lower pump volume via the outlet port in the second valve body during the downstroke of the pump piston, and allows fluid into the lower pump volume via the inlet port in the second valve body during the upstroke of the pump piston.

In one or more of the embodiments described herein, the valve body includes a plurality of inlet ports and outlet ports, and the first and second plates are coupled to a plurality of blocking members for blocking the respective plurality of inlet and outlet ports.

In another embodiment, a method of pumping fluid from a wellbore includes deploying a pump assembly into the wellbore, the pump assembly having a pump piston and a first and second valve assembly, each valve assembly comprising: a valve body with an outlet port and an inlet port, a first plate coupled with a blocking member for blocking the outlet port when the first plate is in a closed position, and a second plate coupled with a blocking member for blocking the inlet port when the second plate is in a closed position; driving the piston pump in an upstroke, thereby unseating the blocking member of the first plate in the first valve assembly and unseating the blocking member of the second plate in the second valve assembly; and driving the piston pump in a downstroke, thereby unseating the blocking member of the second plate in the first valve assembly and unseating the blocking member of the first plate in the second valve assembly.

In one or more of the embodiments described herein, each valve body includes a plurality of outlet ports, and each first plate is coupled to a plurality of blocking members for blocking the plurality of outlet ports.

In one or more of the embodiments described herein, each valve body includes a plurality of inlet ports, and each second plate is coupled to a plurality of blocking members for blocking the plurality of inlet ports.

In one or more of the embodiments described herein, the blocking member of the first plate is formed integrally with the first plate.

In one or more of the embodiments described herein, the blocking member of the first plate is attached to the first plate.

In one or more of the embodiments described herein, the blocking member of the second plate is formed integrally with the second plate.

In one or more of the embodiments described herein, the blocking member of the second plate is attached to the second plate.

In one or more of the embodiments described herein, driving the piston pump in the upstroke includes: discharging production fluid above the piston pump via the outlet port in the first valve assembly; and collecting production fluid below the piston pump via the inlet port in the second valve assembly.

In one or more of the embodiments described herein, driving the piston pump in the downstroke includes: discharging production fluid below the piston pump via the outlet port in the second valve assembly; and collecting production fluid above the piston pump via the inlet port in the first valve assembly.

In one or more of the embodiments described herein, the outlet port is blocked by seating the blocking member of the first plate on a corresponding profile formed in the valve body.

In one or more of the embodiments described herein, the inlet port is blocked by seating the blocking member of the second plate on a corresponding profile formed in the valve body.

While the foregoing is directed to embodiments of the present invention, other and further embodiments of the invention may be devised without departing from the basic scope thereof, and the scope thereof is determined by the claims that follow.

1. A valve assembly, comprising:
a valve body having a first port and a second port, the first port forms a fluid pathway from a first surface of the valve body to a second surface of the valve body, and the second port forms a fluid pathway from the second surface of the valve body to a third surface of the valve body;
a first plate having a first blocking member, the first blocking member configured to block the first port at the first surface of the valve body when the first plate is in a first closed position; and
a second plate having a second blocking member, the second blocking member configured to block the second port at the second surface of the valve body when the second plate is in a second closed position.

2. The valve assembly of claim 1, wherein the first blocking member is not free to rotate relative to the first port.

3. The valve assembly of claim 1, wherein the valve body includes a plurality of first ports, and the first plate includes a plurality of corresponding first blocking members.

4. The valve assembly of claim 1, wherein the first blocking member is coupled to the first plate.

5. The valve assembly of claim 1, wherein the first port has a profile at the first surface of the valve body for receiving the first blocking member.

6. The valve assembly of claim 1, wherein the first and second plates are configured to cooperate such that, when the first plate is in the first closed position, the second plate is in an open position, and vice versa.

7. The valve assembly of claim 1, wherein the first blocking member is configured to hermetically seal the first port.

8. The valve assembly of claim 1, wherein the first blocking member includes a conical solid, a rectangular solid, or an ellipsoid.

9. The valve assembly of claim 1, wherein the first blocking member comprises a metal material, a rubber material, or a plastic material.

10. The valve assembly of claim 1, further comprising a first cage, wherein the first plate is movably disposed in the first cage between an open position and the first closed position.

11. The valve assembly of claim 1, further comprising a biasing member between the first plate and the first cage for biasing the first plate towards the first closed position.

12. A method of forming a valve assembly, comprising:
providing a valve body with a port that forms a fluid pathway from a first surface of the valve body to a second surface of the valve body, wherein the port at the first surface forms a seat;
disposing a blocking member in the seat; and
attaching a plate to the blocking member disposed in the seat.

13. The method of claim 12, further comprising attaching a cage to the valve body, wherein a biasing member is disposed between the plate and the cage.

14. The method of claim 12, wherein the valve body includes a plurality of ports forming a plurality of seats, and the plate is attached to a plurality of corresponding blocking members disposed in the plurality of seats.

15. The method of claim 12, wherein attaching the plate to the blocking member includes gluing, welding, and/or brazing the plate to the blocking member.

16. A pump assembly, comprising:
a pump piston designed to move up and down in alternating strokes between an upper pump volume and a lower pump volume; and
a first and second valve assemblies, each valve assembly comprising:
a valve body with an outlet port and an inlet port,
a first plate having a blocking member coupled thereto for blocking the outlet port when the first plate is in a closed position, and
a second plate having a blocking member coupled thereto for blocking the inlet port when the second plate is in a closed position,
wherein the first valve assembly allows fluid out of the upper pump volume via the outlet port in the first valve body during an upstroke of the pump piston and allows fluid into the upper pump volume via the inlet port in the first valve body during a downstroke of the pump piston, and
wherein the second valve assembly allows fluid out of the lower pump volume via the outlet port in the second valve body during the downstroke of the pump piston and allows fluid into the lower pump volume via the inlet port in the second valve body during the upstroke of the pump piston.

17. The pump assembly of claim 16, wherein the valve body includes a plurality of inlet ports and outlet ports, and the first and second plates are coupled to a plurality of blocking members corresponding to the plurality of inlet and outlet ports.

18. A method of pumping fluid from a wellbore, comprising:
deploying a pump assembly into the wellbore, the pump assembly having a pump piston and a first and second valve assembly, each valve assembly comprising:
a valve body with an outlet port and an inlet port,
a first plate coupled with a blocking member for blocking the outlet port when the first plate is in a closed position, and
a second plate coupled with a blocking member for blocking the inlet port when the second plate is in a closed position;
driving the piston pump in an upstroke, thereby unseating the blocking member of the first plate in the first valve assembly and unseating the blocking member of the second plate in the second valve assembly; and
driving the piston pump in a downstroke, thereby unseating the blocking member of the second plate in the first valve assembly and unseating the blocking member of the first plate in the second valve assembly.

19. The method of claim 18, wherein each valve body includes a plurality of outlet ports, and each first plate is coupled to a plurality of blocking members for blocking to the plurality of outlet ports.

20. The method of claim 18, wherein driving the piston pump in the upstroke includes:
discharging production fluid above the piston pump via the outlet port in the first valve assembly; and
collecting production fluid below the piston pump via the inlet port in the second valve assembly.

21. The method of claim 18, wherein driving the piston pump in the downstroke includes:
discharging production fluid below the piston pump via the discharge port in the second valve assembly; and
collecting production fluid above the piston pump via the intake port in the first valve assembly.

22. The method of claim 18, wherein the outlet port is blocked by seating the blocking member of the first plate on a corresponding profile formed in the valve body.
